(19) United States
(12) Patent Application Publication
(10) Pub. No.: US 2011/0132277 A1
(43) Pub. Date: Jun. 9, 2011

(54) Animal Restraint System

(75) Inventor: Graham McAtamney, Stockleigh (AU)

(73) Assignee: GJ Air-Ride Pty Ltd., Stockleigh, Queensland (AU)

(21) Appl. No.: 13/057,518

(22) PCT Filed: Aug. 6, 2009
(86) PCT No.: PCT/AU2009/001006

§ 371 Date: Feb. 4, 2011

(30) Foreign Application Priority Data
Aug. 7, 2008 (AU) 2008904044

(51) Int. Cl. A01K 15/04; F16K 15/20

(52) U.S. Cl. 119/752; 137/223

(57) ABSTRACT

An animal restraint system for use during the transportation of animals comprising a region in which an animal is confined, one or more inflatable restraining means located within the region, at least one regulator for selectively increasing and/or decreasing the size of the one or more restraining means, and wherein a preselected value of inflation or deflation of the restraining means is maintained by the regulator.

### FIELD OF THE INVENTION

The present invention relates to an animal restraint system. In particular, the present invention relates to an animal restraint system to be used when transporting animals, or when animals must be restrained, such as for inspection or veterinary purposes.

### BACKGROUND ART

When transporting animals (for instance, by road or by air) it is generally necessary to restrain the animal in some manner. For instance, domestic animals or even zoo animals may be placed in a box or crate for transportation, while larger animals, such as horses, may be placed in trailers, floats or the like for transportation. The purpose of restraining animals in this way is to restrict an animal's movement so that the animal does not unbalance a vehicle, or, through their movement, interfere with a driver, passenger or other animals that are also being transported.

Typical transportation devices (crates, boxes, floats etc) are limited in that they are constructed in certain standard sizes, meaning that if an animal to be transported is not a standard size, the animal may not be properly restrained. An improperly restrained animal may be a danger to people and other animals due to its ability to move within its restraint. In addition, placing an animal in a improperly sized restraint system may also result in injury to the animal during transportation. This is particularly of concern when rare or valuable animals (for instance, zoo animals or racehorses) are being transported.

Similarly, when inspecting animals, such as in a crush (for instance, for the purposes of veterinary or other treatment, inspection for quarantine, the shoeing of horses or the like) the animal must be properly restrained in order to prevent injury to itself, people or other animals, or damage to property.

Some attempts have been made to overcome this problem. For instance, some forms of transportation (such as horse floats) may be provided with padding on their walls so that, if an animal moves during transportation, the padding will absorb the animal's impact. However, the padding does not prevent the animal from moving, but merely cushions the animal's impact should it happen to slip or fall during transportation.

Thus, there would be an advantage if it were possible to provide an animal restraint system that was able to effectively restrain animals during transportation. In addition, there would be an advantage if the animal restraint system could be adapted to restrain animals of differing sizes.

It will be clearly understood that, if a prior art publication is referred to herein, this reference does not constitute an admission that the publication forms part of the common general knowledge in the art in Australia or in any other country.

Throughout this specification, the term “comprising” and its grammatical equivalents shall be taken to have an inclusive meaning unless the context of use indicates otherwise.

### OBJECT OF THE INVENTION

It is an object of the present invention to provide an animal restraint system which may overcome at least some of the abovementioned disadvantages, or provide a useful or commercial choice.

In one aspect, the invention resides broadly in an animal restraint system for use during the transportation of animals comprising a region in which an animal is confined, one or more inflatable restraining means located within the region, at least one regulator for selectively increasing and/or decreasing the size of the one or more restraining means, and wherein a preselected value of inflation or deflation of the restraining means is maintained by the regulator.

In one embodiment of the invention, increasing the size of the one or more restraining means restricts the movement of an animal confined within the region. In another embodiment of the invention, increasing the size of the one or more restraining means provides additional padding for the animal within the region. This may be of importance should the animal slip or fall, such as during transportation.

The present invention provides a number of significant advantages over the prior art. Firstly, selectively increasing and decreasing the size of the one or more restraining means provides the user with a flexible system in that the degree of restraint of an animal may be varied depending on the reason for why the animal is being restrained. For instance, an animal may only be lightly restrained during transportation, while during a veterinary examination or procedure, for instance, the degree of restraint may be significantly increased in order to prevent the animals injuring itself or the people examining the animal. Alternatively, when, for instance, a pregnant animals is being transported, the degree of restraint may be increased so as to prevent injury to the animal or baby.

In addition, the ability to adjust the size of the one or more restraining means allows the same system to be used for animals of differing sizes. For instance, a light restraint on a smaller animal may be an over-restrictive restraint on a larger animal.

Thus, the ability to adjust the size of the one or more restraining means has the advantage that a plurality of sizes (or even types) of animals may be confined in a region with a similar degree of restraint for each animal.

Thus, it is envisaged that the system may be used in connection with animals such as livestock (cattle, sheep, goats, pigs etc), exotic animals such as llamas or alpacas, horses, domestic animals (such as dogs and cats), zoo animals or the like.

The region in which the animal is confined may be of any suitable form. For instance, the region may include an enclosed (or partially-enclosed) crate, box or container into which an animal is loaded for transportation. Alternatively the region may be a pen, stall, enclosure or crush, for instance at a zoo, farm, horse stud, quarantine station, veterinary clinic or the like. Still further, the region may form a part of a vehicle, such as a horse or livestock transportation vehicle, trailer, float or the like.

In a preferred embodiment of the invention, the region is provided with one or more support surfaces. The one or more support surfaces may be of any suitable form, although in some embodiments of the invention, the one or more support surfaces may include walls, partitions, barriers, bars, posts, rails or the like. Preferably, the one or more restraining means are located relative to the one or more support surfaces. The one or more restraining means may be located relative to the one or more support surfaces in any suitable manner. For instance, the one or more restraining means may be connected directly to the one or more support surfaces. Alternatively, the one or more restraining means may be connected via an intermediate support to the one or more support surfaces. The intermediate support may be of any suitable form, such as, but not limited to, one or more boards, panels, hooks, projections, tabs, lands or the like to which the one or more restraining means are mounted, the intermediate support then being mounted to the one or more support surfaces.

It is envisaged that an intermediate support will be used when the animal restraint system is being retrofitted to an existing region, while it is envisaged that the one or more restraining means will be connected directly to a support surface in a purpose built region. However, a skilled addressee will understand that the invention is not limited to this, and it may be possible to connect the one or more restraining means directly to a support surface when the system is being retrofitted. In addition, it may be possible to use an intermediate support when fitting the system to a purpose built region.

In some embodiments of the invention, the restraining means may be removably attached to the support surface or intermediate support. Thus, in these embodiments of the invention, the restraining means may be removed from the region for maintenance, cleaning, replacement or when not required.

The one or more restraining means may be of any suitable form. As mentioned previously, the size of the one or more restraining means may be increased or decreased. This may be achieved using any suitable technique, although in a preferred embodiment of the invention, the one or more restraining means are inflatable. The one or more restraining means may be inflated using any suitable method, such as by filling the one or more restraining means with a media, such as one or more liquids, gases, solutions, suspensions or the like, or any combination thereof. Preferably, however, the restraining means are inflated using a gas. In some embodiments of the invention, the gas is air.

When it is desired to increase the size of the restraining means, a flow of media into the restraining means is generated. Similarly, when it is desired to decrease the size of the restraining means, a flow of media out of the restraining means is generated. The flow of media may be generated using any suitable technique, such as a flow of liquid (or solution etc) between a reservoir and the restraining means or a flow of gas between a reservoir (such as a gas cylinder or the like) and the restraining means. Alternatively, the size of the restraining means may be increased or decreased by making use of a pump (whether mechanical or manually operated) or a compressor (such as an air compressor) to generate a flow of media into or out of the restraining means. In yet another embodiment of the invention, the one or more restraining means may be adapted to be inflated manually (i.e. using expired air from a person's lungs). In a preferred embodiment of the invention, the one or more restraining means may be adapted to be inflated and deflated using a combination of these techniques.

In a preferred embodiment of the invention, the flow of media into or out of the restraining means is controlled. It may be desirable to control the flow of media in order to prevent over-inflation of the restraining means (which may cause damage to the restraining means) or under-inflation of the restraining means (in which case the desired degree of animal restraint is nor achieved). The control of the flow of media may be achieved using any suitable technique. In a preferred embodiment of the invention, the flow of media is controlled using one or more regulators. Preferably, the regulator monitors one or more parameters (such as, but not limited to the volume and/or size and/or pressure of the restraining means). In some embodiments of the invention, the desired value of the one or more parameters may be preselected (using any suitable method) and the regulator may maintain the one or more parameters at the desired value. In a most preferred embodiment of the invention, the regulator is a pressure regulator.

Thus, the role of the regulator may be twofold: 1) the regulator may be used to set the size of the restraining means to a desired size dependent on the type and size of animal that is to be transported, and 2) the regulator may be used to maintain the size of the restraining means at the preselected value during transportation of the animal. It will be understood that the ability to adjust the size of the restraining means ensures that a variety of types of animal (as well as different size animals of the same variety) may be transported in the same region by adjusting the size of the restraining means.

The one or more restraining means may be of any suitable type and configuration. In a preferred embodiment of the invention, the restraining means are inflatable. Thus, any suitable inflatable means may be used, although a skilled addressee will understand that the restraining means must be sufficiently robust so as to resist damage or breakage if an animal places its weight against the restraining means.

In some embodiments of the invention, the restraining means comprises an inflatable body only. In these embodiments of the invention, the inflatable body may be fabricated from any suitable material, such as, but not limited to, plastic (e.g. polyurethane).

In other embodiments of the invention, the restraining means comprises an inflatable body (such as a bladder) fixedly or removably contained within a cover or housing, or a backing member. In this embodiment of the invention, the cover, housing or backing member may be constructed of a resilient material adapted to withstand the impact of an animal's weight against the restraining means. Preferably, however, the cover or housing is also of sufficient flexibility to allow the inflatable body housed within the cover or housing to increase and decrease in size as required. In a preferred embodiment of the invention, the cover or housing may be adapted to be abrasion resistant, UV resistant, tear resistant, chemical resistant, heat resistant or any combination thereof. In addition, the cover or housing may be fabricated from an anti-fungal and/or wrinkle resistant material.

The restraining means may be of any suitable size or shape. A skilled addressee will understand that the size and shape of the restraining means may vary depending on the animal being restrained, and the purpose for which the animal is being restrained

In some embodiments of the invention, the one or more restraining means are provided in a deflated state and are selectively inflated to increase the restraint of an animal in a region. In other embodiments of the invention, the one or more restraining means are provided in an inflated state and are selectively deflated in order to reduce the restraint of an animals in a region. Preferably, however, the one or more restraining means are capable of both inflation and deflation.

In some embodiments of the invention, a single restraining means may be provided. Preferably, however, a plurality of restraining means are provided. This is particularly the case if an animal is being transported. In this case, it may be necessary to provide a plurality of support surfaces in the transportation device (e.g. horse float, crate, container etc) with restraining means to protect the animal. In some embodiments of the invention, a plurality support surfaces may be provided with one or more restraining means.

In some embodiments of the invention, such as when the system is used in a vehicle in which more than one animal may be transported, it is envisaged that the vehicle may comprise two or more regions into which animals may be placed. In this embodiment of the invention, each of the regions may be provided with one or more restraining means.

In this embodiment, each of the regions may be provided with a standalone system (i.e. each region may be provided with means for increasing and decreasing the size of the restraining means that is not connected to any other region). In other embodiments, the one or more restraining means in each of the regions are interconnected, so that a single media source for increasing and decreasing the size of the restraining means is required. For instance, the system may comprise two or more regions, each region being provided with one or more restraining means, but only a single means (e.g. one air compressor) for increasing and decreasing the size of the restraining means.

In embodiments of the invention in which two or more regions are present, each of the restraining means may be interconnected such that each restraining means must be increased uniformly in size. Alternatively, it is envisaged that the restraining means in each region may be increased in size independently of one another, such that different sizes (or types) of animals may be transported in adjacent regions. In addition, it is envisaged that if one or more regions are not in use, the restraining means in the regions not in use will remain deflated. This may be achieved using any suitable technique, such as, but not limited to, isolating the regions not in use from the rest of the system (i.e. using isolation valves), supplying each of the two or more regions with a regulator, providing each region with one or more dump valves to release the (for instance) air from the region or the like, or any combination thereof.

Further, it is envisaged that in embodiments of the invention in which each region comprises more than one restraining means that each of the restraining means within a single region may be adapted for inflation and/or deflation to a level different to that of the other restraining means within the same region. This may be achieved using any suitable means, such as, but not limited to, a dump valve or the like.

In another aspect, the invention resides broadly in a restraining device for animals, the restraining device comprising a regulator and one or more inflatable restraining means, the size of the one or more restraining means being adapted for selective increase and/or decrease wherein a preselected value of inflation or deflation of the restraining means is maintained by the regulator, and wherein the one or more restraining means are adapted for connection to one or more support surfaces.

### BRIEF DESCRIPTION OF THE DRAWINGS

An embodiment of the invention will be described with reference to the following drawings in which:

FIG. 1 illustrates an animal restraint system according to an embodiment of the present invention;

FIG. 2 illustrates an animal restraint system according to an embodiment of the present invention;

FIG. 3 illustrates restraining means according to an embodiment of the present invention;

FIGS. 4-7 illustrate schematic diagrams of animal restraint systems according to various embodiments of the present invention.

### DETAILED DESCRIPTION OF THE DRAWINGS

It will be appreciated that the drawings have been provided for the purposes of illustrating preferred embodiments of the present invention and that the invention should not be considered to be limited solely to the features as shown in the drawings.

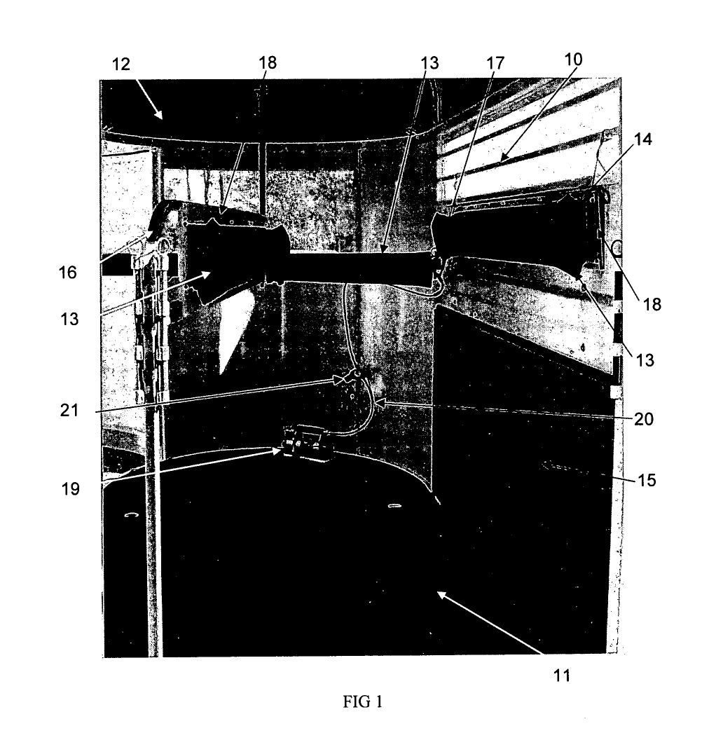

In FIG. 1 there is illustrated an animal restraint system 10 according to an embodiment of the present invention. The system 10 comprises a region 11 adapted to house an animal. In the embodiment illustrated in FIG. 1 the region 11 is a stall in a horse float 12.

The system 10 illustrated in FIG. 1 comprises a plurality of restraining means 13 in the form of inflatable bladders (obscured) housed within an outer cover 14. The restraining means 13 are connected via intermediate supports 18 to support surfaces that define the region 11, including a wall 15, a divider 16 and a chest bar 17. The restraining means 13 are removably connected to the intermediate supports 18. In this way, the restraining means 13 may be removed from the intermediate supports 18 for cleaning, repair, maintenance or replacement.

The selective increase and/or decrease in the size of the restraining means 13 may be achieved using an air compressor 19. The air compressor 19 is connected to the restraining means using flexible tubing 20. The system 10 is further provided with a regulator 21 that allows the inflation of the restraining means 13 to be set and controlled at a predetermined value, such as a pressure value.

In the embodiment of the invention illustrated in FIG. 1, the restraining means 13 are interconnected such that all of the restraining means 13 are inflated simultaneously.

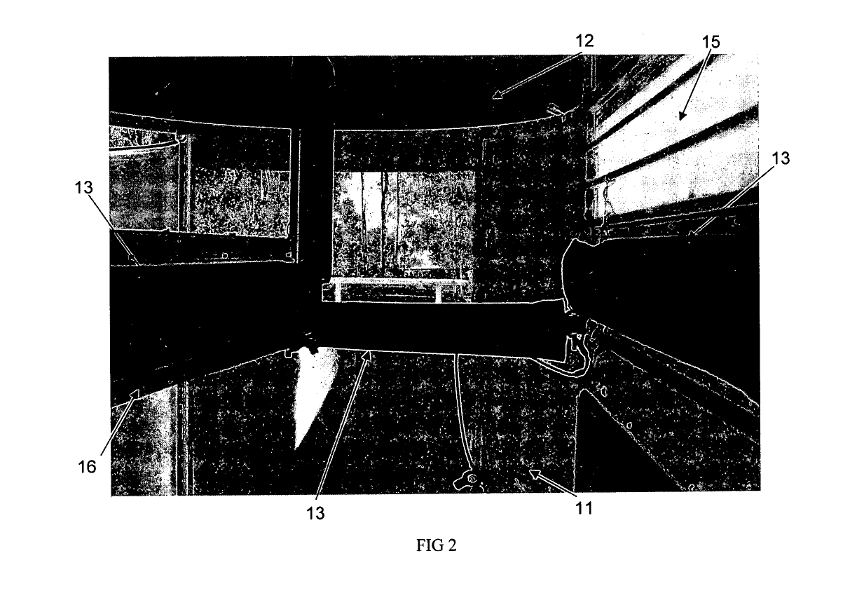

In FIG. 2, the restraining means 13 may be more clearly seen. When an animal (not shown) enters the region 11, the compressor (not shown) may be actuated, thereby causing the restraining means 13 to inflate. As the restraining means 13 inflate, they come into contact with the sides and chest of the animal. Further inflation of the restraining means 13 restricts the movement of the animal within the region 11, such that, during transportation for instance, the animal will not be able to move freely within the region. This serves two main purposes: if the animal becomes startled, it will not be able to make any sudden movements that could injure itself, a person or cause the float 12 to become unbalanced. Secondly, restricting the movement of the animal (not shown) means that, for instance during cornering or braking, the animal will not slip and crash into the wall 15 or the divider 16, thereby injuring itself or damaging the float 12.

Depending on the reason for the animal (not shown) being in the region 11, and the state of the animal (e.g. is the animal pregnant, for instance), the degree of inflation of the restraining means 13 may be varied to allow the animal some degree of movement if preferred.

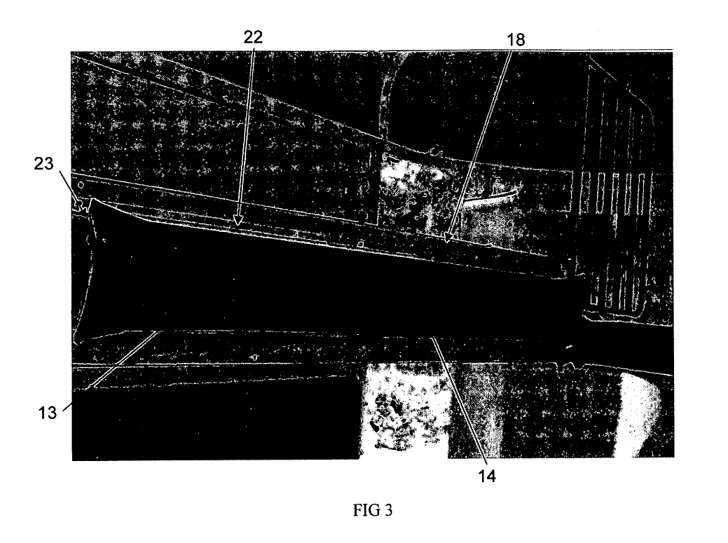

In FIG. 3, one of the restraining means 13 may be more clearly seen. The restraining means 13 comprises a cover 14 having an opening 23 in one end that allows an inflatable bladder (obscured) to be slid in and out of the cover 14. The cover 14 is provided with a pair of rails (obscured) on its reverse side which are adapted to engage with a complementary pair of rails 22 on the intermediate support 18. In this way, the restraining means 13 may be removed from the intermediate support as required.

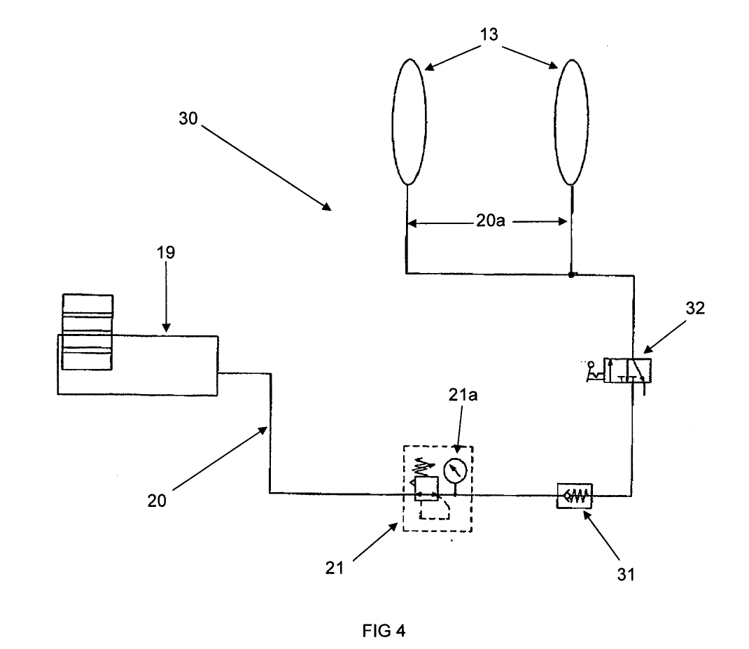

In FIG. 4 there is shown an animal restraint system 30 according to an embodiment of the present invention. The system 30 is provided with a pair of restraining means 13 for engaging with the sides of a single animal (not shown) to be transported.

The system 30 comprises an air compressor 19 that is connected via flexible tubing 20 to a regulator 21. In the embodiment illustrated in FIG. 4, the free air delivery of the air compressor 19 is approximately 10 bar (150 psi), while the regulator 21 has a maximum input pressure of approximately 12 bar (176 psi) and an out put pressure in the range of between approximately 0.05 bar (0.7 psi) and 0.7 bar (9.8 psi).

The purpose of the regulator 21 is to inflate or deflate the restraining means 13 to a preselected value and then maintain the level of inflation at that value during use. The regulator 21 allows a user to manually change the degree of inflation as required. In addition, the regulator 21 is provided with a gauge 21 a that allows a user to ensure that the regulator 21 is maintaining the desired level of inflation.

The system illustrated in FIG. 4 further comprises a one-way valve 31 adapted to prevent leakage of air from the restraining means 13 back to the regulator 21. In addition, the system 30 comprises a dump valve 32 that allows a user to manually deflate the restraining means 13 should it be desired to do so. In addition, the dump valve 32 allows for one of the restraining means 13 to be inflated or deflated to a level that is different to that of the other of the restraining means 13 in the system 30.

In the system 30 illustrated in FIG. 4, the portions of the flexible tubing 20a connected to the restraining means 13 are housed in piping (not shown) that, for instance, is aligned on the wall of a horse float or the like.

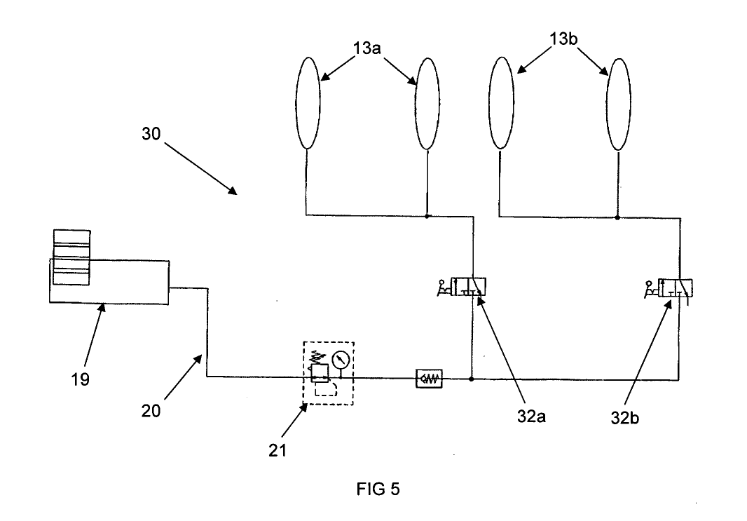

In FIG. 5, an alternative embodiment of the system 30 of FIG. 4 is illustrated. In this Figure, the system 30 comprises two pairs of restraining means 13a, 13b for engaging with the sides of an animal (not shown).

As with the system of FIG. 4, the system 30 shown in FIG. 5 comprises an air compressor 19 connected to a regulator 21 by flexible tubing 20.

In FIG. 5, each of the pairs of restraining means 13a, 13b is provided with a dump valve 32a, 32b that allow a user to selectively inflate only one of said pair of restraining means 13a, 13b or to inflate the pairs of restraining means 13a, 13b to different levels of inflation to one another. In this way, the inflation of the pairs of restraining means 13a, 13b may be varied if, for instance, only one animal is being transported, or if two animals of differing types or sizes are being transported together, or if a particular animal requires additional inflation of the restraining means due to pregnancy or injury.

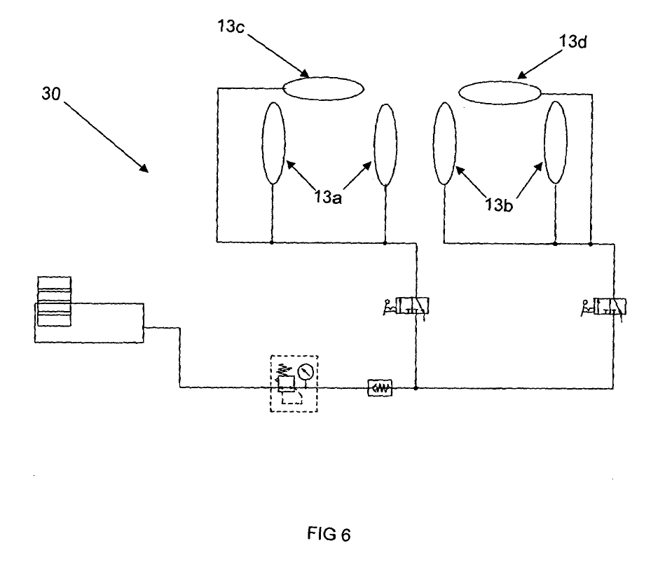

In FIG. 6 there is shown a an animal restraint system 30 according to a further embodiment of the present invention. The system 30 of FIG. 6 is virtually identical to that of FIG. 5 except that the groups of restraining means comprise a pair of restraining means 13a, 13b for the sides of the animal (not shown) as well as a front restraining means 13c, 13d for location adjacent an animal's chest in order to provide additional restraint and/or protection for the animal during transportation.

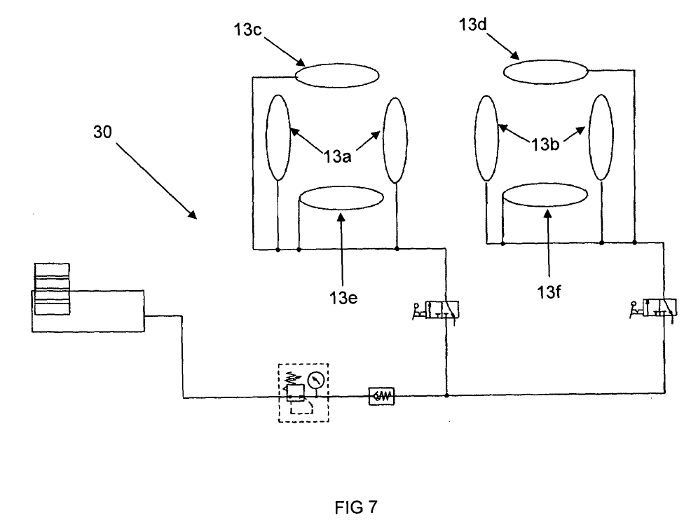

Similarly, FIG. 7 illustrates a system 30 that comprises two groups of restraining means comprising a pair of restraining means 13a, 13b for the sides of the animal (not shown), a front restraining means 13c, 13d for location adjacent an animal's chest, and rear restraining means 13e, 13f for location adjacent an animal's rear in order to provide additional restraint and/or protection for the animal during transportation.

Those skilled in the art will appreciate that the present invention may be susceptible to variations and modifications other than those specifically described. It will be understood that the present invention encompasses all such variations and modifications that fall within its spirit and scope.

1. An animal restraint system for use during the transportation of animals comprising a region in which an animal is confined, at least a pair of opposed inflatable restraining means located within the region and mounted to at least a pair of fixed support surfaces, at least one regulator for controlling the inflation of the one or more restraining means to a preselected value, and wherein the preselected value of inflation or deflation of the restraining means is maintained by the regulator.

2. An animal restraint system as claimed in claim 1 wherein the region is chosen from one of an enclosed crate, box or container or a partially enclosed crate, box or container into which an animal is loaded for transportation, a part of a vehicle, such as a horse or livestock transportation vehicle, trailer, or float.

3. An animal restraint system as claimed in claim 2 wherein the region is at least partially defined by the one or more fixed support surfaces with at least one restraining means located relative to each fixed support surface.

4. An animal restraint system as claimed in claim 3 wherein an intermediate support located between the fixed support surface and the restraining means is used when the animal restraint system is being retrofitted to an existing region.

5. An animal restraint system as claimed in claim 1 wherein the restraining means is removably attached to the fixed support surface.

6. An animal restraint system as claimed in claim 1 wherein the one or more restraining means is inflated by filling the one or more restraining means with a media chosen from one of liquids, gases, solutions, suspensions or the like, or any combination thereof.

7. An animal restraint system as claimed in claim 1 wherein a reservoir is provided for inflation of the restraining means from media stored in the reservoir.

8. An animal restraint system as claimed in claim 1 wherein the size of the restraining means is increased or decreased by making use of a pump or compressor to generate a flow of media into or out of the restraining means.

9. An animal restraint system as claimed in claim 1 wherein the one or more restraining means is adapted to be inflated manually.

10. (canceled)

11. An animal restraint system as claimed in claim 1 wherein the restraining means comprises an inflatable body.

12. An animal restraint system as claimed in claim 1 wherein the restraining means comprises an inflatable body mounted relative to a backing member for inflation and deflation of the restraining means.

13. An animal restraint system as claimed in claim 1 wherein the one or more restraining means are initially in a deflated state and are selectively inflated to increase the restraint of an animal in the region.

14. An animal restraint system as claimed in claim 1 wherein a plurality of restraining means are provided spaced about the region and adapted to abut the animal in use to restrict movement of the animal.

15. An animal restraint system as claimed in claim 1 including a plurality of regions each including a plurality of restraining means and each of the regions is provided with a standalone inflation and deflation system.

16. A restraining device for animals, the restraining device comprising a regulator and at least a pair of opposed inflatable restraining means, the size of the restraining means being adapted for controlled increase and/or decrease to a preselected value of inflation or deflation, wherein the preselected value of inflation or deflation of the restraining means is maintained by the regulator, and wherein the restraining means are adapted for connection to at least a pair of opposed fixed support surfaces.
